(19) United States
(12) Patent Application Publication
(10) Pub. No.: US 2017/0093512 A1
(43) Pub. Date: Mar. 30, 2017

(54) CLOCK INTERFACE WITH PROPAGATION DELAY CALIBRATION FUNCTION

(71) Applicant: Alcatel Lucent, Boulogne-Billancourt (FR)

(72) Inventor: Hao ZHU, Shanghai (CN)

(21) Appl. No.: 15/265,037

(22) Filed: Sep. 14, 2016

(30) Foreign Application Priority Data
Sep. 30, 2015 (CN) 201510642268.X

(51) Int. Cl. H04J 3/06; H04L 7/00

(52) U.S. Cl. CPC H04J 3/0682; H04L 7/0054

(57) ABSTRACT

A clock interface includes measuring unit configured to receive a 1PPS input signal from a galvanic isolated transceiver, and measure a propagation delay of at least one of the 1PPS input signal and an 1PPS output signal; and a local PTP engine configured to receive the 1PPS input signal and compensate the 1PPS input signal using the measured propagation delay. After measuring starts, the clock interface sequentially pulls up a 1PPS input of the local PTP engine to a high level; disconnects a 1PPS input and a 1PPS output of the transceiver from the upstream timing master and a downstream timing slave, respectively; disconnects ground of the transceiver from the chassis ground, and connects the chassis side ground of the transceiver to a digital ground inside the clock interface; and connects the IPPS input and the 1PPS output of the transceiver to measuring unit, respectively.

### FIELD OF THE INVENTION

The present disclosure generally relates to the field of communication transmission, and more specifically relates to a clock interface with a propagation delay calibration function.

### BACKGROUND OF THE INVENTION

Standardization of the Precision Time Protocol (PTP) project in the International Telecommunication Union Telecommunication Standardization Sector (ITU-T) has always been in an evolution process. In May 2014, G.8273.2 (first release) was published, which specified PTP's synchronization performance in phase and time. Therefore, many telecommunication carriers (e.g., France Telecom) require that the PTP performance should satisfy G.8273.2 specifications. In G.8273.2, constant phase/time error is specified within +/−50 ns (nanoseconds) in Class A and within +/−20 ns in Class B. Existing implementation of 1PPS (1 pulse per second) interface in some devices uses galvanic isolated RS-422 transceiver whose inherent propagation delay in transmitter direction is typically about 60 ns and in receiver direction is typically about 90 ns. Also the inherent propagation delay varies from chip to chip and at different temperatures. Without effective propagation delay calibration method, it is impossible for existing PTP implementations to fulfill even Class A constant phase/time error requirement in a galvanic isolated way. Therefore, the following technical problems in three aspects may be faced to fulfill effective propagation delay calibration in a galvanic isolated manner.

1. Signal and power are partitioned into digital and chassis parts by a galvanic isolated RS-422 transceiver, while the calibration circuit normally works in the digital part. How can circuits working in digital part and chassis part interwork during measurement/calibration and how can they be isolated from each other during normal operation (not in measurement/calibration)?

2. To measure/calibrate the propagation delay in receiver direction, a local PTP engine may temporarily lose its 1PPS input from an upstream timing master. To measure/calibrate the propagation delay in the transmitter direction, downstream timing slave may temporarily lose its 1PPS input from the local PTP engine. Can the measurement/calibration be timing hitless for 1PPS input (from upstream timing master) or output (to downstream timing slave) of the local PTP engine so that it can be used at any time and under any application?

3. 1PPS signal has 1 pulse per second. In current measurement/calibration, propagation delay measurement is performed once for each second and then several seconds are waited to average the results, so there is a problem as to how to expedite the measurement/calibration.

### SUMMARY OF THE INVENTION

To address at least one of the problems above, the present disclosure provides a clock interface with a propagation delay calibration function.

According to one aspect of the present disclosure, there is provided a clock interface with a propagation delay calibration function. The clock interface includes a galvanic isolated transceiver configured to receive a 1PPS input signal from an upstream timing master and output a 1PPS output signal to a downstream timing slave; a propagation delay measuring unit configured to receive the 1PPS input signal from the transceiver, and measure a propagation delay of at least one of the 1PPS input signal and the 1PPS output signal during a propagation delay measuring period; and a local PTP engine configured to receive the 1PPS input signal from the transceiver and compensate the 1PPS input signal using the propagation delay measured by the propagation delay measuring unit, and output the compensated 1PPS output signal. After the propagation delay measuring period starts, the clock interface sequentially: pulls up a 1PPS input of the local PTP engine to a high level; disconnects a 1PPS input and a 1PPS output of the transceiver from the upstream timing master and the downstream timing slave, respectively; disconnects a chassis side ground of the transceiver from a chassis ground, and connects the chassis side ground of the transceiver to a digital ground inside the clock interface; and connects the IPPS input and the 1PPS output of the transceiver to the propagation delay measuring unit, respectively.

In this way, galvanic isolation between the chassis part and the digital part of the clock interface is guaranteed in a manner of 3-stage switches, and timing hitless during the propagation delay measurement and calibration period is also guaranteed.

According to a further implementation, the clock interface further includes a trip circuit comprising a first buffer, a second buffer and a clamping resistance. The first buffer is configured to buffer the 1PPS input signal from the transceiver and transmit it to the propagation delay measuring unit; the second buffer is configured to buffer the 1PPS input signal from the transceiver and transmit it to the local PTP engine; and the clamping resistance is located between the second buffer and the 1PPS input of the local PTP engine, for pulling up the 1PPS input of the local PTP engine to a high level during the propagation delay measuring period.

According to a further implementation, the first buffer and the second buffer are same buffers.

According to a further implementation, the clock interface further includes an accelerated clock generator configured to generate a clock signal with a frequency higher than that of a 1PPS signal during the propagation delay measuring period, the clock signal or the 1PPS output signal outputted by the local PTP engine being selected and inputted into the propagation delay measuring unit.

According to a further implementation, the downstream timing slave has an input open-circuit protection feature.

According to a further implementation, the downstream timing slave does not have an input open-circuit protection feature, and the clock interface further includes a parallel circuit configured to, at an early stage of the propagation delay measuring period, before the chassis side ground of the transceiver is disconnected from the chassis ground and the 1PPS input and the 1PPS output of the transceiver are connected to the propagation delay measuring unit, respectively, pull up the 1PPS output signal of the transceiver to a high level.

In addition, the parallel circuit may be further configured to, at a late stage of the propagation delay measuring period, before the chassis side ground of the transceiver is connected to the chassis ground and the 1PPS input and the 1PPS output of the transceiver are disconnected from the propagation delay measuring unit, respectively, pull down the 1PPS output signal of the transceiver to a low level.

According to a further implementation, the clock interface further includes a switch set including a first switch, a second switch, a third switch, a fourth switch, and a fifth switch. A fixed terminal of the first switch is connected to the 1PPS input of the transceiver, a first switching terminal of the first switch is connected to the upstream timing master, a second switching terminal of the first switch is connected to a fixed terminal of the third switch, a fixed terminal of the second switch is connected to the 1PPS output of the transceiver, a first switching terminal of the second switch is connected to the downstream timing slave, a second switching terminal of the second switch is connected to a first switching terminal of the fourth switch, a fixed terminal of the third switch is connected to a second switching terminal of the first switch, a first switching terminal of the third switch floats, a second switching terminal of the third switch is connected to the 1PPS output of the local PTP engine, a fixed terminal of the fourth switch is connected to the propagation delay measuring unit, a first switching terminal of the fourth switch is connected to a second switching terminal of the second switch, a second switching terminal of the fourth switch floats, a fixed terminal of the fifth switch is connected to the chassis side ground of the transceiver, a first switching terminal of the fifth switch is connected to the chassis ground, and a second switching terminal of the fifth switch is connected to the digital ground.

According to a further implementation, the transceiver is a RS-422 transceiver.

### BRIEF DESCRIPTION OF THE ACCOMPANYING DRAWINGS

The present disclosure will be understood better and other objectives, details, features and advantages of the present disclosure will become more obvious after reading the depiction of the preferred embodiments of the present disclosure with reference to the accompanying drawings. In the drawings:

FIG. 1 illustrates a schematic diagram of a clock interface with an inherent propagation delay calibration function using a non-isolated RS-422 transceiver;

FIG. 2 illustrates a schematic diagram of a clock interface with an inherent propagation delay calibration function according to a preferred embodiment of the present disclosure;

FIG. 3 illustrates a schematic timing sequence diagram of a clock interface with a propagation delay calibration function according to the present disclosure when performing propagation delay measurement and calibration operations; and

FIG. 4 illustrates a schematic timing sequence diagram of a clock interface with an inherent propagation delay calibration function according to the present disclosure when performing another round of delay measurement and calibration after performing a round of propagation delay measurement and calibration.

It may be understood that in the present specification, same or similar reference numerals indicate same or similar elements.

### DETAILED DESCRIPTION OF THE PREFERRED EMBODIMENTS

Hereinafter, the preferred embodiments of the present disclosure will be described in more detail with reference to the accompanying drawings. Although the preferred embodiments of the present disclosure are illustrated in the drawings, it should be understood that the present disclosure may be implemented in various manners and should not be limited by the embodiments illustrated herein. Instead, providing these embodiments is to make the present disclosure more thorough and complete and to enable the scope of the present disclosure to be completely conveyed to those skilled in the art.

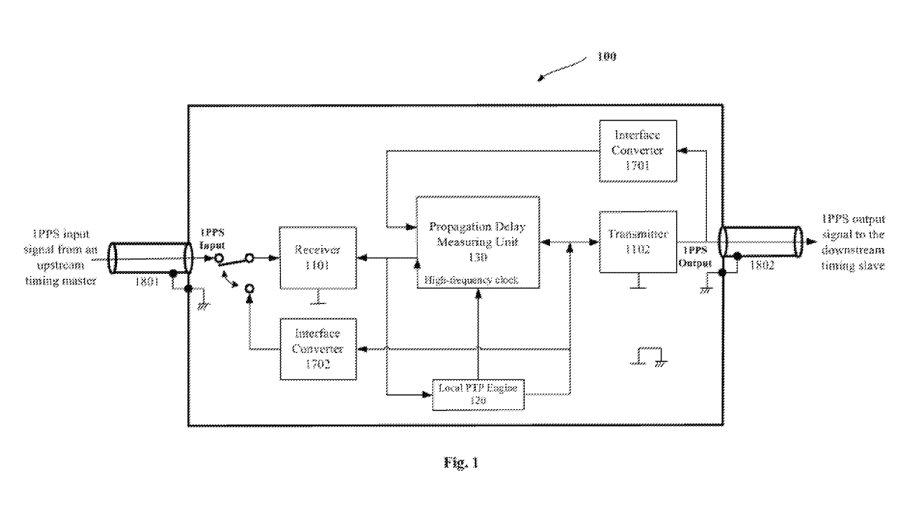

FIG. 1 illustrates a schematic diagram of a clock interface 100 with an inherent propagation delay calibration function using a non-isolated RS-422 transceiver. As illustrated in FIG. 1, the clock interface 100 includes a non-isolated RS-422 transceiver 110 (including a receiver 1101 and a transmitter 1102), a local PTP engine 120, a propagation delay measuring unit 130, input and output interface converters 1701 and 1702, and input shielding connector 1801 and an output shielding connector 1802.

In the clock interface 100, the propagation delay measuring unit 130 measures delay of the 1PPS signal at the transmitter 1102 and the receiver 1101 once per second (supposing that the delay introduced by interface converters 1701 and 1702 may be ignored relative to the delay introduced by the RS-422 transceiver). Repeat the same measurement for multiple times. After an average propagation delay of the RS-422 transceiver 110 is compensated in the local PTP engine 120, the constant frequency/time error as specified in G.8273.2 may be fulfilled.

By tying the chassis ground and the digital ground together through certain mechanical designs, the solution as illustrated in FIG. 1 uses a non-isolated RS-422 transceiver instead of a galvanic isolated transceiver. This simplifies the interface circuit design, but it is not versatile in some complex electromagnetic environment where galvanic isolated clock interface has to be used.

Besides, in order to measure/calibrate propagation delay in the receiver direction, the local PTP engine 120 may temporarily loss the 1PPS input signal from the upstream timing master. Although the local PTP engine 120 may enter into a PTP time holdover state, strictly speaking, the propagation delay measurement is not timing hitless since the phase/time of the local PTP engine 120 will offset from the upstream timing master. Furthermore, during the measurement, loss of the input 1PPS signal from the upstream timing master will generate a relevant software alarm, unless this alarm is blocked by software.

The duration of propagation delay measurement is relatively long. Since the propagation delay measuring unit 130 may only derive one result each second, it has to take several seconds to obtain an average result. This enlarges the phase time offset between the local PTP engine 120 and the upstream timing master.

The present disclosure provides a clock interface with a propagation delay calibration function. Since a galvanic isolated transceiver is used, this clock interface is more suitable for a complex electromagnetic environment. The clock interface according to the present disclosure guarantees galvanic isolation during the operation period in a manner of 3-stage switches. Besides, the clock interface according to some aspects of the present disclosure provides a timing hitless propagation delay measurement and calibration function. Besides, the clock interface according to some other aspects of the present disclosure achieves faster propagation delay measurement and calibration.

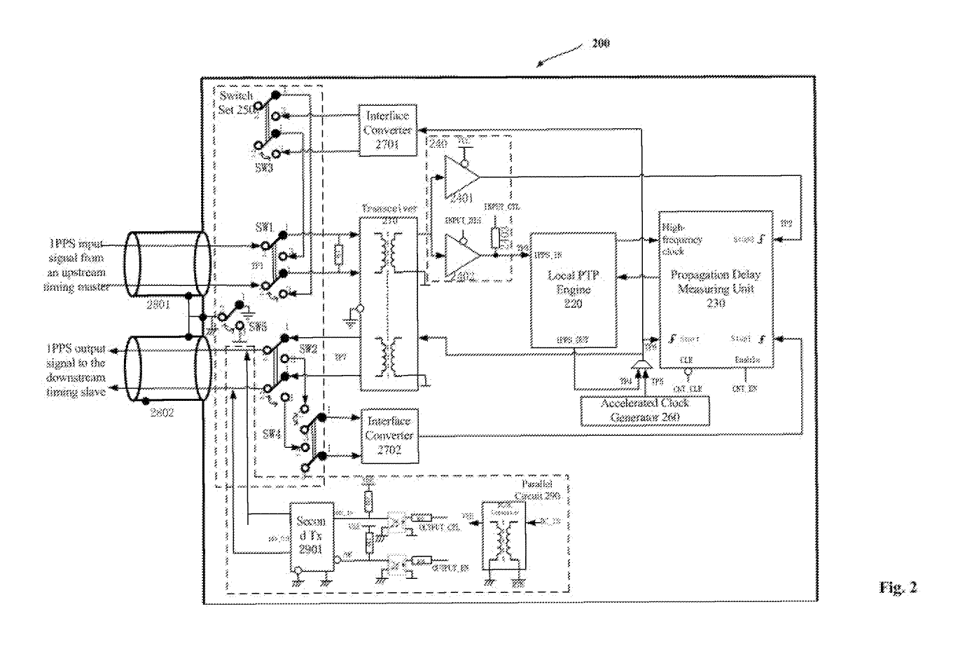

FIG. 2 illustrates a schematic diagram of a clock interface 200 with an inherent propagation delay calibration function according to a preferred embodiment of the present disclosure.

As illustrated in FIG. 2, the clock interface 200 comprises a galvanic isolated transceiver 210 configured to receive a 1PPS input signal from an upstream timing master and output a 1PPS output signal to a downstream timing slave.

In one implementation, the transceiver 210 may be a galvanic isolated RS-422 transceiver.

The clock interface 200 further comprises a local PTP engine 220 configured to receive a 1PPS input signal from the transceiver 210 and a propagation delay measuring unit 230 configured to receive the 1PPS input signal from the transceiver 210 and measure a propagation delay of the 1PPS input signal and/or a 1PPS output signal during a propagation delay measuring period.

The propagation delay measuring unit 230 may measure only the propagation delay of the 1PPS input signal or only the propagation delay of the 1PPS output signal, and/or may measure the propagation delays of both, as required.

The propagation delay measured by the propagation delay measuring unit 230 is also inputted to the local PTP engine 220 for compensation of the 1PPS input signal received by the local PTP engine 220, and the compensated 1PPS output signal is outputted.

The clock interface 200 is characterized in: after the propagation delay measuring period starts, sequentially performing: pulling up the 1PPS input (1PPS_IN) of the local PTP engine 220 to a high level, disconnecting the 1PPS input and 1PPS output of the transceiver 210 from the upstream timing master and the downstream timing slave, respectively, disconnecting a chassis side ground of the transceiver 210 from the chassis ground and connecting it to the digital ground inside the clock interface 200, and connecting the 1PPS input and the 1PPS output of the transceiver 210 to the propagation delay measuring unit 230, respectively. Moreover, before completion of the propagation delay measuring period, the clock interface 200 sequentially performs: pulling down the 1PPS input of the local PTP engine 220 to a low level, disconnecting the 1PPS input and the 1PPS output of the transceiver 210 from the propagation delay measuring unit 230, respectively, connecting the chassis side ground of the transceiver 210 to the chassis ground and disconnecting from the digital ground inside the clock interface 200, and connecting the 1PPS input and 1PPS output of the transceiver 210 to the upstream timing master and the downstream timing slave, respectively.

Since it is difficult to guarantee that any two switches may be switched at completely the same time, through sequential switching of the three-stage switches, it is implemented that the chassis side ground of the transceiver 210 is disconnected from the chassis ground, and the IPPS input and output are disconnected from the external and connected to the measuring circuit inside the clock interface 200. At the late stage of the delay measuring period, by performing a reverse sequential procedure of the three-stage switches, it may be implemented that the chassis side ground of the transceiver 210 is connected to the chassis ground, and the 1PPS input and 1PPS output are connected to the external while disconnected from the measuring circuit inside the clock interface 200. By pulling up the 1PPS input of the local PTP engine 220 to a high level or pulling it down to a low level during the propagation delay measuring period and by performing galvanic isolation between the chassis part and the digital part of the clock interface in the manner of three-stage switches, not only normal operation of the clock interface 200 and galvanic isolation during the propagation delay measurement and calibration period are guaranteed, but also timing hitless during the propagation delay measurement and calibration period is guaranteed.

In one implementation, the three-stage switches are implemented by a switch set 250. The switch set 250 comprises a first switch SW1, a second switch SW2, a third switch SW3, a fourth switch SW4, and a fifth switch SW5.

As illustrated in FIG. 2, a fixed terminal 1 of the first switch SW1 is connected to the 1PPS input of the transceiver 210; a first switching terminal 2 of the first switch SW1 is connected to the upstream timing master; a second switching terminal 3 of the first switch SW1 is connected to a fixed terminal 1 of the third switch SW3; a fixed terminal 1 of the second switch SW2 is connected to the 1PPS output of the transceiver 210; a first switching terminal 2 of the second switch SW2 is connected to the downstream timing slave; a second switching terminal 3 of the second switch SW2 is connected to a first switching terminal 2 of the fourth switch SW4; a fixed terminal 1 of the third switch SW3 is connected to a second switching terminal 3 of the first switch SW1; a first switching terminal 2 of the third switch SW3 floats; a second switching terminal 3 of the third switch SW3 is connected to the 1PPS output (1PPS_OUT) of the local PTP engine 220; a fixed terminal 1 of the fourth switch SW4 is connected to the propagation delay measuring unit 230; a first switching terminal 2 of the fourth switch SW4 is connected to a second switching terminal 3 of the second switch SW2; a second switching terminal 3 of the fourth switch SW4 floats; a fixed terminal 1 of the fifth switch SW5 is connected to a chassis side ground of the transceiver 210; a first switching terminal 2 of the fifth switch SW5 is connected to the chassis ground; and a second switching terminal 3 of the fifth switch SW5 is connected to the digital ground.

During the propagation delay measuring period, the first and second switches SW1 and SW2 operate simultaneously so as to disconnect the 1PPS input and the 1PPS output of the transceiver 210 from the upstream timing master and the downstream timing slave, respectively. Then, the fifth switch SW5 disconnects the chassis side ground of the transceiver 210 from the chassis ground and connects the chassis side ground to the digital ground inside the clock interface 200. Finally, the third and fourth switches SW3 and SW4 operate simultaneously so as to connect the 1PPS input and 1PPS output of the transceiver 210 to the propagation delay measuring unit 230, respectively.

Those skilled in the art may understand that the above compositions and connection relationships of the switch set 240 is only an exemplary manner of implementing galvanic isolated three-stage switches. The switch set 240 may also comprise more or less switches, or may employ switches of different types from the switches SW1-SW5 in the figure or implement different connection relationships between these switches.

For example, although the switches SW1-SW4 are illustrated in FIG. 2 as being implemented using a dual-channel switch, those skilled in the art may understand that one or more of the switches SW1-SW4 may be implemented using a combination of two single-channel switches.

Further, according to some aspects of the present disclosure, the clock interface 200 may also comprise a trip circuit 240, comprising a first buffer 2401, a second buffer 2402, and a clamping resistance 2403. The first buffer 2401 is configured to buffer the 1PPS input signal from the transceiver 210 and transmit it to the propagation delay measuring unit 230. The second buffer 2402 is configured to buffer the 1PPS input signal from the transceiver 210 and transmit it to the local PTP engine 220. The clamping resistance 2403 is located between the second buffer 2402 and the 1PPS input of the local PTP engine 220, for pulling up the 1PPS input of the local PTP engine 220 to a high level during the propagation delay measuring period.

In one implementation, the first buffer 2401 and the second buffer 2402 are same buffers, therefore they introduce the same propagation delays, which facilitates maintaining timing consistency between the measuring operation in the propagation delay measuring unit 230 and the calibration operation in the local PTP engine 220. However, those skilled in the art may understand that the present disclosure is not limited thereto. The first buffer 2401 and the second buffer 2402 may also be different buffers, as long as the propagation delays introduced thereby are definite.

Furthermore, according to some aspects of the present disclosure, the clock interface 200 may also comprise an accelerated clock generator 260 configured to generate a clock signal with a frequency higher than that of the 1PPS signal during the propagation delay measuring period. The clock signal or the 1PPS output signal outputted by the local PTP engine 220 is selected (e.g., selected by the control signal CNT_EN of the propagation delay measuring unit 230) and inputted into the propagation delay measuring unit 230.

With the accelerated clock signal generated by the accelerated clock signal generator 260, multiple measurements can be performed within one propagation delay measurement period, and the measurement results may be averaged to obtain an average delay. Compared with measuring once per second in the prior art, which has to take several seconds to perform calibration, the present disclosure apparently enhances the speed of propagation delay measuring and calibrating operations.

Besides, in some implementations, the downstream timing slave has an input open-circuit protection feature. The input open-circuit protection feature means that when the receiver input of the downstream timing slave is open, its receiver output is at a high level.

In this case, before the chassis side ground of the galvanic isolated transceiver 210 is disconnected from the chassis ground and the 1PPS input and output are disconnected from the external and connected to the internal measurement circuit, the 1PPS output signal of the transceiver 210 is fixed to a high level due to the input open-circuit protection feature of the transceiver 210. Therefore, after completion of the propagation delay measurement, and after the chassis side ground of the galvanic isolated transceiver 210 is connected back to the chassis ground and the 1PPS input and output are disconnected from the internal propagation delay measuring unit and connected back to the external, before respective falling edges of the 1PPS input and output signals, the local PTP engine 220 and the downstream timing slave will not notice any changes of their inputs. Therefore, for the local PTP engine 220 and the downstream timing slave, timing hitless and relevant alarm of the 1PPS signal loss will not occur during the measurement period.

In some other implementations, the downstream timing slave does not have an input open-circuit protection feature. In this case, the clock interface 200 may further include a parallel circuit 290 illustrated within the dotted-line block at the left bottom part of FIG. 2.

The parallel circuit 290 is used for pulling up the 1PPS output signal of the transceiver 210 to a high level before the chassis side ground of the transceiver 210 is disconnected from the chassis ground and the 1PPS input and 1PPS output of the transceiver 210 are connected to the propagation delay measuring unit 230, respectively.

As illustrated in FIG. 2, the parallel circuit 290 comprises a second transmitter 2901, for locking the 1PPS signal output of the transceiver 210 to a high level or a low level under the control of the control signals OUTPUT_CTL and OUTPUT_EN.

Here, the second transmitter 2901 may be a galvanic isolated or non-isolated RS-422 transmitter.

Furthermore, as illustrated in FIG. 2, the clock interface 200 also comprises an interface converter 270 (including an input interface converter 2701 and an output interface converter 2702), for converting the input analog level (e.g., TTL level or CMOS level or LVDS level, etc.) into a level suitable for the transceiver 210 so as to he inputted into the transceiver 210, or converting the level suitable for the transceiver 210 into an output analog level so as to be outputted to the external.

Furthermore, although FIG. 2 does not illustrate in detail, a control logic should also be included inside the clock interface 200 or outside the clock interface 200, for generating control signals for controlling respective components of the clock interface 200, e.g., CTRL1, CTRL2, CTRL3, INPUT_DIS, INPUT_CTL, CNT_CLR, CNT_EN, OUTPUT_CTL, OUTPUT_EN, etc., as will be detailed later.

Those skilled in the art may understand that although the present disclosure takes 1 pulse per second (1PPS) as an example for illustration, the idea of the present disclosure may be equivalently suitable for a pulse signal with other periods or various equivalent forms or evolutions of the 1PPS signal currently existing or future developed.

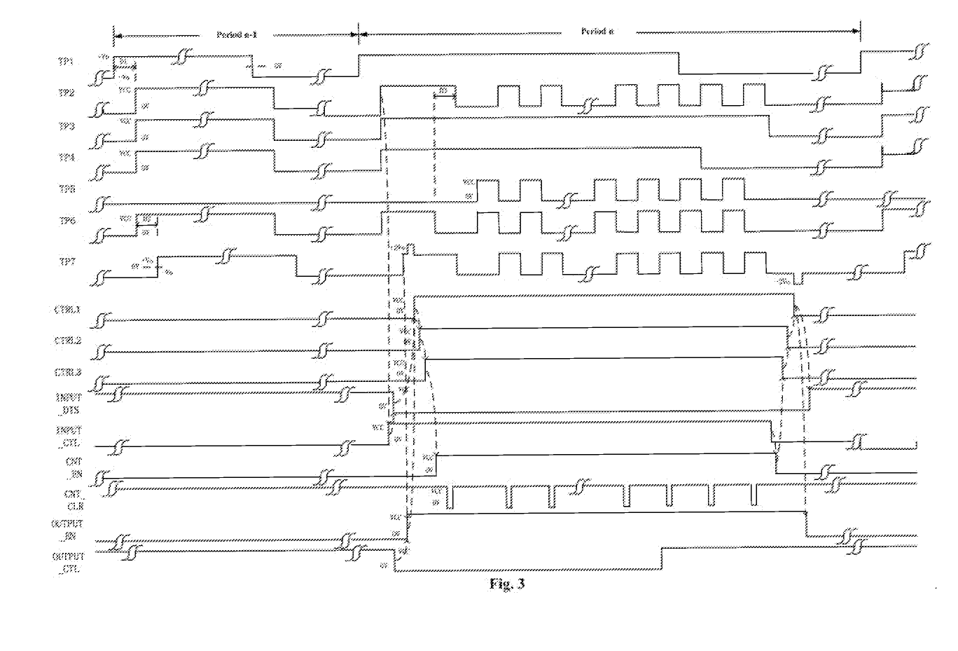

FIG. 3 illustrates a schematic timing sequence diagram of a clock interface with a propagation delay calibration function according to the present disclosure when performing propagation delay measurement and calibration operations. Hereinafter, the propagation delay measurement and calibration operation of the clock interface 200 in FIG. 2 will be described in more detail with reference to FIG. 3.

In order to facilitate illustration, signal waveforms at test points TP1-TP7 in the clock interface 200 and signal waveforms of various control signals are depicted.

Herein, the test point TP1 indicates a waveform of the 1PPS input signal of the transceiver 210. The test point TP2 indicates a signal waveform of the 1PPS input signal from the transceiver 210 inputted into the propagation delay measuring unit 230 through the first buffer 2401. The test point TP3 indicates a signal waveform of the 1PPS input signal from the transceiver 210 inputted to the local PTP engine 220 through the second buffer 2402 and the clamp resistance 2403. The test point TP4 indicates a signal waveform outputted from the 1PPS signal output of the local PTP engine 220. The test point TP5 indicates an exemplary waveform of an accelerated clock signal generated by the accelerated clock generator 260. The test point TP6 indicates a waveform after signal selection at the test point TP4 and test point TP5. The test point TP7 indicates a waveform of the 1PPS output signal of the transceiver 210.

Furthermore, the control signal CTRL1 is for simultaneously controlling the first switch SW1 and the second switch SW2. The control signal CTRL2 is for controlling the fifth switch SW5. The control signal CTRL3 is for simultaneously controlling the third switch SW3 and the fourth switch SW4.

In FIG. 3, it is supposed that the inherent propagation delay measurement and calibration is performed during the period n, and it is supposed that the inherent propagation delay of the transceiver 210 has not been measured and calibrated before the period n.

1. In a normal period before the period n, e.g., period n−1, the 1PPS signal waveforms at the test points TP1-TP3 are illustrated in the figure. It is seen that due to receiver delay of the transceiver 210 and propagation delay of the first and second buffers 2401 and 2402, the waveforms at the test points TP2 and TP3 are delayed by D1 relative to the test point TP1. Note that it is assumed here that the first buffer 2401 and the second buffer 2402 are of the same type, therefore it may be believed that the two buffers almost have the same propagation delay, such that the waveforms of the test points TP2 and TP3 are almost identical. Since the local PPT engine 220 is locked to the TP3 waveform, the test points TP4 and TP6 will have an almost same phase-locked waveform as that of the test point TP3. The waveform of the test point TP7 is further delayed by D2 due to propagation delay of the transmitter of the transceiver 210. Therefore, the transmitter delay and receiver delay of the transceiver 210 and the propagation delay of the buffers 2401 and 2402 constitute a total time difference between the 1PPS input (TP1 waveform) and output (TP7 waveform), i.e., D1+D2.

2. In period n, after the rising edge of the waveform TP2, the control signal INPUT_CTL becomes high so as to pull up the clamp resistance 2403 to a high level, and then the control signal INPUT_DIS goes low such that the output of the second buffer 2402 becomes a high-resistance state, and the output of the local PTP engine 220 is pulled up. In this way, during the propagation delay measurement period, the local PTP engine 220 will not notice any change of its 1PPS input signal (i.e., timing hitless).

3. In period n, after the rising edge of the TP7 waveform, the control signal OUTPUT_CTL for the parallel circuit 290 goes low, and then OUTPUT_EN becomes high. This makes the parallel circuit 290 to work so as to lock the 1PPS signal output of the transceiver 210 to a high level. Those skilled in the art may understand that this is addressed to the downstream timing slave without an input open-circuit protection feature. For the downstream timing slave with an input open-circuit protection feature, the parallel circuit 290 may be not required, such that the control signals OUTPUT_CTL and OUTPUT_EN are not required.

After the control signal OUTPUT_CTL goes low and the OUTPUT_EN goes high, the amplitude and DC component of the 1PPS output signal towards the downstream timing slave become twice of that of a normal RS-422 clock interface, but it is still within an absolute maximum rational value range for the receiver input of the downstream timing slave.

Within a very short time after the second buffer 2402 output is disabled and the second transmitter 2901 output is enabled, the first switch SW1 and the second switch SW2 are controlled by the control signal CTRL1 to simultaneously switch, thereby the input and output 1PPS signals of the transceiver 210 are disconnected from the external and become floating (not connected to the internal measurement circuit yet till now). However, the local PTP engine 220 and the downstream timing slave will not notice any change of their 1PPS inputs.

4. After the first switch SW1 and the second switch SW2 are completely switched, the fifth switch SW5 is switched by the control signal CTRL2, such that the chassis side ground of the transceiver 210 is disconnected from the chassis ground and connected to the internal digital ground. After the fifth switch SW5 is completely switched, the third switch SW3 and the fourth switch SW4 are simultaneously switched by the control signal CTRL3 such that the 1PPS input and output signals of the transceiver 210 are connected to the internal measuring circuit. This three-stage switching circuit and sequential operation may provide a fully isolated protection during the delay measurement period and during the switch switching period.

5. After the chassis side ground of the galvanic isolated transceiver 210 is disconnected from the chassis ground and the 1PPS input and output are disconnected from the external and connected to the internal propagation delay measuring unit 230, the propagation delay measuring unit 230 and the accelerated clock generator 260 begin to work under the control of CNT_EN. The accelerated clock generator 260 generates an accelerated clock signal with a frequency higher than the frequency (1 Hz) of 1PPS.

In this way, the propagation delay measuring unit 230 may obtain a plurality of samples and calculate an average result in one second. This facilitates propagation delay measurement and calibration.

The accelerated clock generator 260 obtains an accelerated clock signal by frequency dividing a high frequency (e.g., 125 MHz or 25 MHz) clock used by the local PTP engine 220. The maximum frequency of the accelerated clock signal is limited by the maximum propagation delay of the transceiver 210. In principle, the maximum propagation delay of the receiver or transmitter should be less than one period of the accelerated clock signal.

It may be seen that the maximum number of the measurement samples that can be obtained in the period n is limited by the processing time needed by the above steps 2-4 and 6-8 as well as the maximum frequency of the accelerated clock signal.

In one implementation, the maximum number of the samples measured by the propagation delay measuring unit 230 during the period n is rounded to lower nearest 2^{m} (m=0, 1, 2 . . . ). In this way, the average of the samples may be realized through a shift register circuit.

6. While the propagation delay measuring unit 230 performs measurement, in order to guarantee that the positive pulse width of the 1PPS output is within a maximum restriction specified in the standard (in the CCSA (China Communications Standards Association) YD/T 2375-2011 specification, the maximum positive pulse width of the 1PPS signal is limited to 200 ms; and in the ITU-T G.703 Amendment 1, the maximum positive pulse width of the 1PPS signal is limited to 500 ms), the parallel circuit 290 pulls the 1PPS signal output of the transceiver 210 down to a low level. For example, the output of the second transmitter 2901 is controlled to be a low level by the control signal OUTPUT_CTL.

7. Before completion of the measurement of the propagation delay measuring unit 230 (e.g, within a very short time before completion of the measurement), the 1PPS signal output of the transceiver 210 is still fixed to a low level by the parallel circuit 290, and the 1PPS input of the local PTP engine 220 is pulled down to a low level (the output of the second buffer 2402 is disabled) by the output of the second buffer 2402 and the clamp resistance 2403.

After completion of the propagation delay measurement and before the chassis side ground of the galvanic isolated transceiver 210 is connected back to the chassis ground and the 1PPS signal input and output are connected back to the external, in order to guarantee fully isolated protection of the switch set 250 during the switch switching, the three-stage switches of the switch set 250 perform the switching in an order reverse to steps 3-4 above. Therefore, during the measurement and switch switching, the local PTP engine 220 and the downstream PTP slave will not have timing hitless, such that no relevant alarm of 1PPS signal loss will occur.

This solution is insensitive to the duty-cycle of the 1PPS input signal, and even the total processing time is rather long (but has to be within one period of the 1PPS signal), e.g., a slow switch is used, the duty cycle of the 1PPS output signal can also be controlled within the maximum restriction specified in the standards.

8. After the chassis side ground of the galvanic isolated transceiver 210 is connected back to the chassis ground and the PPS signal input and output are connected back to the external, the output of the second transmitter 2901 is disabled and the output of the second buffer 2402 is enabled.

It should be noted that FIG. 3 only illustrates an exemplary situation, i.e., the measurement time exceeds the maximum restriction (200 ms or 500 ms) specified in the standards, and the downstream slave does not have an input open-circuit protection feature. In this case, the parallel circuit 290 is required to pull down the 1PPS output signal of the transceiver 210 to a low level upon completion of the measurement.

On the other hand, if the measurement time (i.e., the total time needed for the above steps 2-8) can be completed within the overlapped positive puke of the 1PPS input and output signals and the downstream timing slave has an input open-circuit protection feature, the parallel circuit 290 may be omitted. In this case, after the n^{th} rising edge of the 1PPS input and output signals and before the chassis side ground of the galvanic isolated transceiver 210 is disconnected from the chassis ground and the 1PPS input and output are disconnected from the external and connected to the internal propagation delay measuring unit 230, the 1PPS output is fixed to a high level by the input open-circuit protection feature, and the 1PPS input of the local PTP engine 220 is pulled up to high by the second buffer 2402 (the second buffer 2402 output is disabled). After the chassis side ground of the galvanic isolated transceiver 210 is disconnected from the chassis ground and the 1PPS input and output are disconnected from the external and connected to the internal propagation delay measuring unit 230, the local PTP engine 220 and the downstream timing slave will not notice any change of their inputs. Within a very short time before completion of the propagation delay measurement, the 1PPS output is still fixed to high by the input open-circuit protection feature, and the 1PPS input of the local PTP engine 220 is fixed to high. After completion of the propagation delay measurement, after the galvanic isolated transceiver 210 is connected back to the chassis ground and the 1PPS input and output are disconnected from the internal propagation delay measuring unit 230 and connected back to the external, and before the n^{th} falling edges of the 1PPS input and output signals, the local PTP engine 220 and downstream timing slave will not notice any change of their inputs. Therefore, for the local PTP engine 220 and downstream timing slave, no timing hitless or relevant alarm of 1PPS signal loss will occur during the measurement period.

Furthermore, if the above steps 2-8 can be completed within the overlapped positive pulse of the 1PPS input and output signals and the downstream timing slave does not have an input open-circuit protection feature, the parallel circuit 290 cannot be omitted. At this time, a high 1PPS output is achieved through the parallel circuit 290, instead of the input open-circuit protection feature.

9. Step 8 is completed before the rising edge of the n+1^{th} period of the 1PPS input and output signals.

Furthermore, it may be seen from FIG. 3 that during the period n, a first falling edge of the TP2 waveform is delayed by D3 relative to the falling edge of the TP6 waveform, wherein D3 is caused by the delay of the receiver of the transceiver 210 and the propagation delay of the interface converter.

The local PTP engine 220 compensates propagation delay of the input and/or output using the measured average inherent propagation delay of the transceiver 210. In this way, the inherent propagation delay of the galvanic isolated clock interface 200 is calibrated.

Using the solution of the present disclosure, after the local PTP engine 220 and the downstream timing slave obtain accurate timing information from the rising edges of the local input and output 1PPS signals, respectively, measurement and compensation can be performed within the overlapped time periods of neighboring two rising edges of the input 1PPS signal and neighboring two rising edges of the output 1PPS signal.

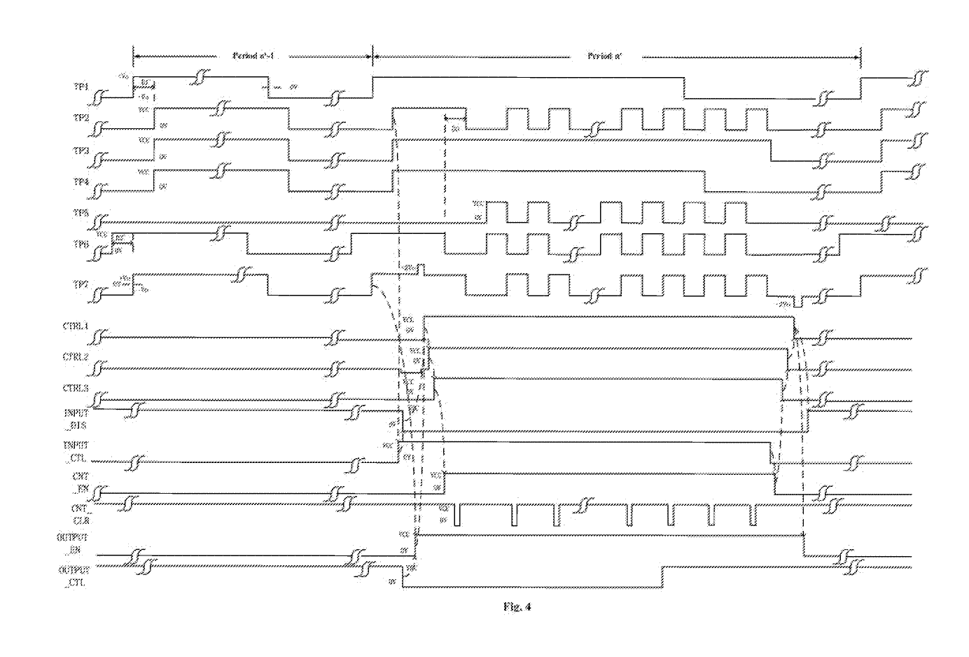

FIG. 4 illustrates a schematic timing sequence diagram of a clock interface with an inherent propagation delay calibration function according to the present disclosure when performing another round of delay measurement and calibration after performing a round of propagation delay measurement and calibration.

In FIG. 4, the period n′−1 illustrates a normal timing sequence diagram after calibration (i.e., not performing delay measurement). Furthermore, the period n′ in FIG. 4 illustrates respective test points of the clock interface 200 and signal waveforms and timing sequence diagrams of respective control signals in another round of delay measurement period.

1. In a normal period, e.g., in the period n′−1, the waveforms of TP2 and TP3 are delayed by D1′ relative to the test point TP1 due to receiver delay of the transceiver 210 and propagation delay of the first and second buffers 2401 and 2402. Since the local PTP engine 220 is locked to the TP3 waveform and the propagation delay of the transceiver 210 is calibrated, the TP6 waveform leads TP3 waveform by one propagation delay D2′ caused by the transmitter of the transceiver 210. The waveform TP7 after being calibrated is completely identical to the waveform phase at TP1.

2. Another round of delay measurement is performed in the period n′, whose time sequence diagram is similar to FIG. 3.

The propagation delay measurement unit 230 may be implemented as a digital phase detector, and it counts a phase difference between waveforms at TP6 and TP2 (with the delay of RS-422 receiver as an example) and calculates an average propagation delay each time. After each measurement, the propagation delay measuring unit 230 is cleared by the control signal CNT_CLR.

In one or more exemplary designs, functions as stated in the present application may be implemented by hardware, software, firmware or any combination thereof.

Various exemplary logic blocks, modules and circuits described in conjunction with the present disclosure may be implemented or executed by a general processor, a digital signal processor (DSP), an application-specific integrated circuit (ASIC), a field-programmable gate array (FPGA) or other programmable logic device, discrete gate or transistor logic, discrete hardware assembly, or any combination for performing the functions stated herein.

For example, according to one or more implementation of the present disclosure, the propagation delay measuring unit 230 and the accelerated clock generator 260 may be implemented through FPGA; the local PTP engine 220 may be implemented through an FPGA and phase locking loop (PLL) circuit; and/or the transceiver 210 and the second transmitter 2901 may be implemented as a separate IC chip.

A person of normal skill in the art should also understand that various exemplary logic blocks, modules, circuits and algorithm steps described in conjunction with the embodiments of the present application may be implemented as electronic hardware, computer software or a combination of both. In order to clearly illustrate such interchangeability between hardware and software, general depiction has been made above to various exemplary components, blocks, modules, circuits and steps with respect to their functions. As to whether the functions are implemented into hardware or software, it depends on specific applications and design restraints imposed on the entire system. Those skilled in the art may implement the described functions in a flexible manner for each specific application. However, such implementation decision should not be construed as departing from the protection scope of the present disclosure.

The above depiction of the present disclosure is to enable any person of normal skill in the art to implement or use the present disclosure. For a person of normal skill in the art, various modifications of the present disclosure are obvious, and a general principle defined herein may also be applied to other transformations without departing from the spirit and protection scope of the present disclosure. Therefore, the present disclosure is not limited to the instances and designs depicted herein; instead, it is in conformity with the broadest scope of the principle and novel features disclosed herein.

1. A clock interface with a propagation delay calibration function comprising:
a galvanic isolated transceiver configured to receive a 1PPS input signal from an upstream timing master and output a 1PPS output signal to a downstream timing slave;
a propagation delay measuring unit configured to receive the 1PPS input signal from the transceiver and measure a propagation delay of at least one of the 1PPS input signal and the 1PPS output signal during a propagation delay measuring period; and
a local PTP engine configured to receive the 1PPS input signal from the transceiver, compensate the 1PPS input signal using the propagation delay measured by the propagation delay measuring unit, and output the compensated 1PPS output signal,
wherein after the propagation delay measuring period starts, the clock interface sequentially:
pulls up a 1PPS input of the local PTP engine to a high level; disconnects a 1PPS input and a 1PPS output of the transceiver from the upstream timing master and the downstream timing slave, respectively; disconnects a chassis side ground of the transceiver from a chassis ground, and connects the chassis side ground of the transceiver to a digital ground inside the clock interface; and connects the IPPS input and the 1PPS output of the transceiver to the propagation delay measuring unit, respectively.

2. The clock interface according to claim 1, further comprising:
a trip circuit comprising a first buffer, a second buffer and a clamping resistance, wherein the first buffer is configured to buffer the 1PPS input signal from the transceiver and transmit it to the propagation delay measuring unit; the second buffer is configured to buffer the 1PPS input signal from the transceiver and transmit it to the local PTP engine; and the clamping resistance is located between the second buffer and the 1PPS input of the local PTP engine, for pulling up the 1PPS input of the local PTP engine to a high level during the propagation delay measuring period.

3. The clock interface according to claim 2, wherein the first buffer and the second buffer are same buffers.

4. The clock interface according to claim 1, further comprising:
an accelerated clock generator configured to generate a clock signal with a frequency higher than that of a 1PPS signal during the propagation delay measuring period, the clock signal or the 1PPS output signal outputted by the local PTP engine being selected and inputted into the propagation delay measuring unit.

5. The clock interface according to claim 1, wherein the downstream timing slave has an input open-circuit protection feature.

6. The clock interface according to claim 1, wherein the downstream timing slave does not have an input open-circuit protection feature, and the clock interface further comprises:
a parallel circuit configured to, at an early stage of the propagation delay measuring period, before the chassis side ground of the transceiver is disconnected from the chassis ground and the 1PPS input and the 1PPS output of the transceiver are connected to the propagation delay measuring unit, respectively, pull up the 1PPS output signal of the transceiver to a high level.

7. The clock interface according to claim 6, wherein the parallel circuit is further configured to, at a late stage of the propagation delay measuring period, before the chassis side ground of the transceiver is connected to the chassis ground and the 1PPS input and the 1PPS output of the transceiver are disconnected from the propagation delay measuring unit, respectively, pull down the 1PPS output signal of the transceiver to a low level.

8. The clock interface according to claim 1, wherein before completion of the propagation delay measurement period, the clock interface sequentially: pulls down the 1PPS input of the local PTP engine to a low level; disconnects the 1PPS input and the 1PPS output of the transceiver from the propagation delay measuring unit, respectively; connects the chassis side ground of the transceiver to the chassis ground and disconnects the chassis side ground from the digital ground within the clock interface; and connects the 1PPS input and the 1PPS output of the transceiver to the upstream timing master and the downstream timing slave, respectively.

9. The clock interface according to claim 1, further comprising:
a switch set comprising a first switch, a second switch, a third switch, a fourth switch, and a fifth switch,
wherein a fixed terminal of the first switch is connected to the 1PPS input of the transceiver, a first switching terminal of the first switch is connected to the upstream timing master, a second switching terminal of the first switch is connected to a fixed terminal of the third switch, a fixed terminal of the second switch is connected to the 1PPS output of the transceiver, a first switching terminal of the second switch is connected to the downstream timing slave, a second switching terminal of the second switch is connected to a first switching terminal of the fourth switch, a fixed terminal of the third switch is connected to a second switching terminal of the first switch, a first switching terminal of the third switch floats, a second switching terminal of the third switch is connected to the 1PPS output of the local PTP engine, a fixed terminal of the fourth switch is connected to the propagation delay measuring unit, a first switching terminal of the fourth switch is connected to a second switching terminal of the second switch, a second switching terminal of the fourth switch floats, a fixed terminal of the fifth switch is connected to the chassis side ground of the transceiver, a first switching terminal of the fifth switch is connected to the chassis ground, and a second switching terminal of the fifth switch is connected to the digital ground.

10. The clock interface according to claim 1, wherein the transceiver is a RS-422 transceiver.
